(19) United States
(12) Patent Application Publication
(10) Pub. No.: US 2006/0018676 A1
(43) Pub. Date: Jan. 26, 2006

(54) Image forming apparatus and control method therefor

(75) Inventor: Eiji Ishii, Toride-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/189,589

(22) Filed: Jul. 26, 2005

(30) Foreign Application Priority Data
Jul. 26, 2004 (JP) 2004-217771

(51) Int. Cl. G03G 15/20

(52) U.S. Cl. 399/33; 399/69

(57) ABSTRACT

This invention provides an image forming apparatus which forms an image more safely even when an abnormality occurs in a fixing device. The image forming apparatus of this invention includes two fixing devices and a fixing controller. Each fixing device includes a switch which supplies power to a fixing heater, a temperature sensor which measures the temperature of the fixing heater, and a comparator which determines from the measured temperature whether or not the fixing heater is normally operating, and outputs an error signal when an abnormality occurs. With this arrangement, when at least one comparator outputs an abnormality signal, the fixing controller can control the switches to stop the supply of power to all the fixing devices, thereby forming an image more safely.

### FIELD OF THE INVENTION

The present invention relates to an image forming apparatus and its control method and, more particularly, to safety control on a plurality of fixing devices in an image forming apparatus having the fixing devices.

### BACKGROUND OF THE INVENTION

Conventionally, in the market of copying machines and printers which are required to cope with various kinds of paper and be highly productive, in order to meet these requirements, an arrangement having a plurality of fixing devices in one image forming apparatus has been proposed. When, for example, a toner image transferred on a paper sheet is heated and pressurized by a fixing device in order to fix the image on a paper sheet, there is a need to arbitrarily adjust the glossiness of a printed image. In order to satisfy this need, a fixing apparatus has been proposed (see, for example, Japanese Patent Laid-Open No. 2000-221821), which has a plurality of fixing devices 1, 2, and 3 arranged in series in the paper passing direction. These fixing devices arbitrarily adjust the glossiness of an image to be printed by switching the numbers of nips formed in the respective fixing devices and the positions where nips are used, when a sheet on which an unfixed toner image is formed is made to pass through the nips in the fixing devices to fix the unfixed toner image on the sheet.

On the other hand, a fixing device in an image forming apparatus generally reaches a high temperature, and thus high safety precausions for users are required. For this reason, when the temperature of the fixing heater of a fixing device exceeds the upper limit value of a temperature control range or does not reach the lower limit value of the temperature control range, processing for such an abnormality must be performed by ON/OFF-controlling the input of an AC power supply. This technique is generally introduced into currently available products.

For example, a target temperature is set for a fixing device in accordance with the state of the printer, and an upper and lower limit temperatures are set for each target temperature. When the temperature of the temperature-controlled fixing device exceeds the upper limit temperature or does not reach the lower limit temperature, it is determined that the device has failed. In addition, there has been proposed a method in which when the temperature of the fixing device has exceeded the above upper limit temperature or has not reached the above lower limit temperature, different failure determination processes are performed depending on whether this has happened after the start of paper feed or after the reception of a vertical sync signal (VSYNC) (see, for example, Japanese Patent Laid-Open No. 5-11663).

For the arrangement above which has a plurality of fixing devices arranged in series in the paper passing direction and switches the numbers of nips formed in the respective fixing devices and the positions where nips are used (Japanese Patent Laid-Open No. 2000-221821), there is conceivable an arrangement in which the abnormality processing method for a fixing device which is disclosed in Japanese Patent Laid-Open No. 5-11663 is applied to each fixing device and allows each fixing device to perform this abnormality processing independently. When it is determined that a fixing device is abnormal, in an image forming apparatus having such an arrangement, and the fixing heater of the fixing device in which the abnormality has found is turned off, it appears as if safety on the image forming apparatus was maintained.

In an image forming apparatus such as that described above, which has a plurality of fixing devices arranged in series, however, when one fixing device becomes abnormal and its fixing heater is turned off, there is a possibility that the ambient temperature is still high. In this case, the operation of peripheral circuits cannot be guaranteed, and for example, the temperature of an adjacent fixing device cannot be properly detected. As a consequence, a secondary abnormality may occur.

In addition, it is not preferable in terms of safety that while an abnormality in one fixing device is detected and no image cannot be formed, power is kept supplied to other fixing devices in which no abnormality has been detected. In addition, such operation is wasteful in terms of power consumption.

### SUMMARY OF THE INVENTION

The present invention has been initially made to solve the above problems in the prior arts, and has as its object to provide an image forming apparatus and its control method in which even if an abnormality occurs in at least one of a plurality of fixing devices in which the image forming apparatus has, image forming operation can be conducted more safely by stopping the supply of power to all the fixing devices.

In order to achieve the above object, an image forming apparatus according to an aspect of the present invention has the following arrangement. The arrangement includes a plurality of fixing devices each including a fixing heater which fixes a developing agent on a recording medium, a switch which turns on/off supply of power to the fixing heater, and an abnormality detection unit which detects an abnormality of the fixing heater, and a control unit which turns off all the switches of the plurality of fixing devices so as to stop supply of power to all the plurality of fixing devices, when an abnormality is detected by the abnormality detection unit of at least one of the fixing devices, regardless of a detection result by the abnormality detection unit of the other fixing devices.

In order to achieve the above object, an image forming method for an image forming apparatus according to another aspect of the present invention has the following steps. There is provided a control method for an image forming apparatus including a plurality of fixing devices each including a fixing heater which fixes a developing agent on a recording medium, a switch which turns on/off supply of power to the fixing heater, and an abnormality detection unit which detects an abnormality of the fixing heater, comprising an abnormality detection step of detecting an abnormality of the fixing heater by using the abnormality detection unit, and a control step of turning off all the switches of the plurality of fixing devices so as to stop supply of power to all the plurality of fixing devices, when an abnormality is detected by the abnormality detection unit of at least one of the fixing devices, regardless of a detection result by the abnormality detection unit of the other fixing device.

In order to achieve the above object, an image forming apparatus according to still another aspect of the present invention has the following arrangement. The arrangement includes a plurality of fixing devices each including a fixing heater which fixes a developing agent on a recording medium, a switch which turns on/off supply of power to the fixing heater, and a serial communication unit which performs communication by using serial data, and a control unit which turns off all the switches of the plurality of fixing devices to stop supply of power to all the plurality of fixing devices when a communication abnormality is detected in the serial communication unit of at least one of the fixing devices.

According to the image forming apparatus and its control method of the present invention, in an image forming apparatus having a plurality of fixing devices, when the occurrence of an abnormality in at least one of the fixing devices is detected, the supply of power to all the fixing devices can be stopped. This makes it possible to form an image more safely.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a control arrangement (software control) for an image forming apparatus having a plurality of fixing devices according to an embodiment of the present invention;

FIG. 2 is a flowchart showing processing to be performed when an abnormality in a fixing device is detected in the control arrangement shown in FIG. 1;

FIG. 3 is a schematic view showing the internal structure of an image forming apparatus according to an embodiment of the present invention;

FIG. 4 is a block diagram showing a control arrangement (hardware control) for an image forming apparatus having a plurality of fixing devices according to an embodiment of the present invention;

FIG. 5 is a block diagram showing a control apparatus (software control) for an image forming apparatus having a plurality of fixing devices (using thermal switches) according to another embodiment of the present invention;

FIG. 6 is a flowchart showing processing to be performed when an abnormality in a fixing device is detected in the control arrangement shown in FIG. 5;

FIG. 7 is a block diagram showing a control arrangement (software control) for an image forming apparatus having a plurality of fixing devices (including serial communication) according to still another embodiment of the present invention;

FIG. 8 is a flowchart showing processing to be performed when an abnormality in a fixing device is detected in the control arrangement shown in FIG. 7; and

FIG. 9 is a view for explaining an example of temperature transition when a temperature abnormality in a fixing device is detected.

### DETAILED DESCRIPTION OF THE PREFERRED EMBODIMENTS

Preferred embodiments of the present invention will now be described in detail in accordance with the accompanying drawings.

A preferred embodiment of the present invention will be described in detail below with reference to the accompanying drawings.

As an image forming apparatus having a plurality of fixing devices according to an embodiment of the present invention, one of various types of image forming apparatuses can be used, in which an electrophotographic means, thermosensible means, thermal transfer means, ink-jet means, and the like form images sent as electrical signals on various kinds of recording media such as plain paper and thermosensible paper by using various kinds of recording agents such as toner and ink.

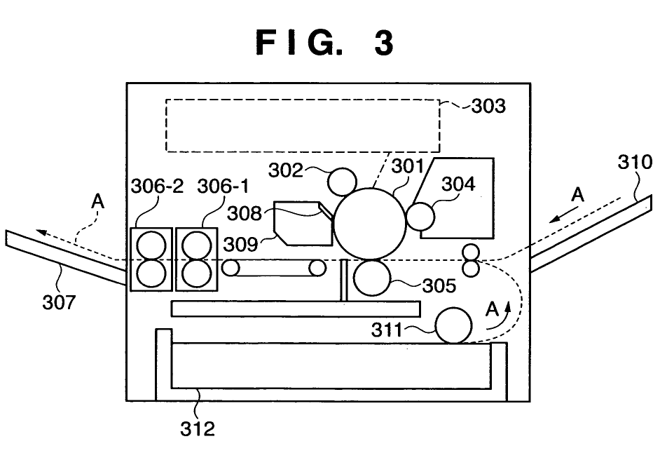

As an example of an image forming apparatus, an image forming apparatus having an image forming unit based on the electrophotographic scheme which has two fixing devices arranged in series and uses a laser beam exposure scheme will be described below. This apparatus uses a printing sheet as a recording medium and toner as a recording agent. However, the number of fixing devices is not limited to two, and three or more fixing devices may be arranged in series. In addition, as an image forming unit, a unit using a scheme other than the laser beam exposure scheme may be used, and a recording medium (e.g., various kinds of printing sheets and OHP (overhead projector) paper) and a recording agent (e.g., ink) may be selected and used in accordance with the scheme.

[Internal Structure of Image Forming Apparatus: FIG. 3]

FIG. 3 is a schematic view showing the internal structure of an image forming apparatus using the laser beam exposure scheme. Referring to FIG. 3, reference numeral 301 denotes a photoconductive drum; 302, a charging device (charging roller); 303, a laser optical system; 304, a developing device; 305, a transfer roller, 306-1 and 306-2, fixing devices; 307, a paper receiving tray; 308, a blade; 309, an exhaust toner container; 310, a manual feed tray; 311, a feed roller; and 312, a paper feed cassette. An optical semiconductor layer whose electrical characteristics change upon application of light is formed on the photoconductive drum 301. This drum rotates at a constant speed during image forming operation. Image forming operation in the above arrangement is performed as follows:
(1) charging step: causing the charging device (charging roller) 302 to uniformly charge the optical semiconductor layer on the photoconductive drum 301;
(2) laser exposure step: causing the laser optical system 303 to apply an image pattern onto the photoconductive drum 301 to form an electrostatic latent image;
(3) development step: causing the developing device 304 to make toner adhere to the electrostatic latent image;
   (4) transfer step: causing the transfer roller 305 to transfer the image, to which the toner adheres, onto a printing sheet;
(5) fixing step: causing the two fixing devices 306-1 and 306-2 arranged in series to fix the toner of the transferred image on the printing sheet by heating and pressurizing the printing sheet, and delivering the printing sheet onto the paper receiving tray 307; and
(6) cleaning step: causing the blade 308 to scrape off toner which is left on the photoconductive drum 301 without being transferred onto the printing sheet, and storing the scraped toner in the exhaust toner container 309.

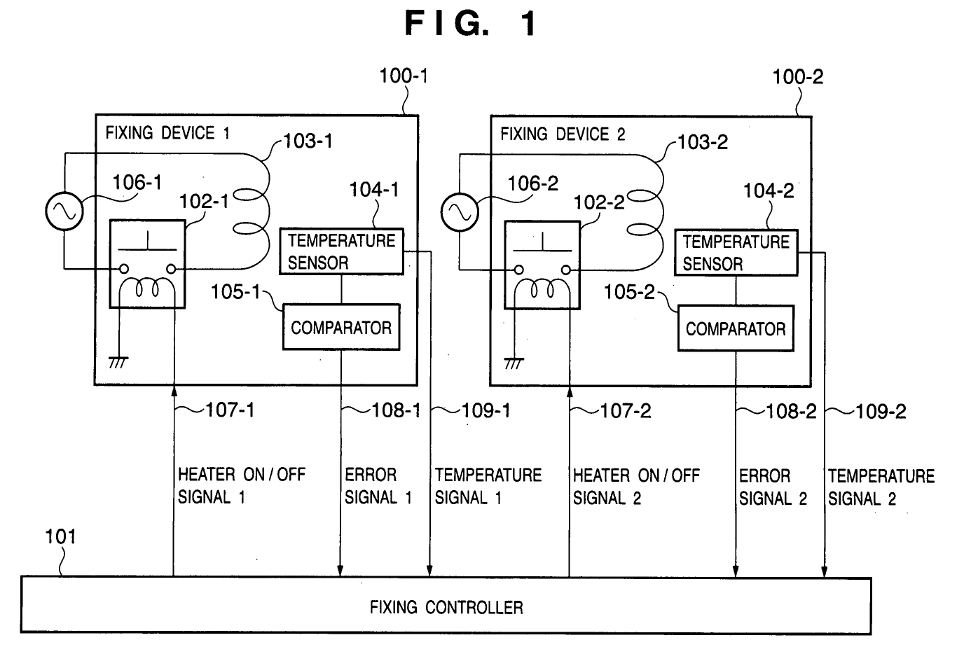

Image forming operation is performed in accordance with the above steps. Note that printing sheets are stacked on the paper feed cassette 312 or manual feed tray 310 and are conveyed to the surface of the photoconductive drum 301 by the feed roller 311 as indicated by a broken line portion A in FIG. 3.

[Control Arrangement (First Arrangement) for Executing Abnormality Processing for Fixing Device: FIG. 1]

Assume that when image printing operation is performed by using the above image forming apparatus, at least one of the two fixing devices becomes abnormal. A control arrangement for abnormality processing in such a case will be described next.

For the sake of simplicity, assume that in the following description, an upper limit temperature Tmax (e.g., 230° C.) and a lower limit temperature Tmin (e.g., 70° C.) are set for the fixing heater of each fixing device, and each fixing device is considered abnormal when (1) the measured temperature of each fixing heater has exceeded the upper limit temperature Tmax for a predetermined time ta (e.g., 2 sec) or more (in case of detection of an excessive temperature rise), or (2) the measured temperature of each fixing heater has not reached the lower limit temperature Tmin (in case of detection of a low temperature) even after a lapse of a predetermined time tb (e.g., 3.5 min).

FIG. 1 is a block diagram showing a control arrangement (first arrangement) for performing abnormality processing for each fixing device described above. This arrangement comprises a fixing controller 101 and two fixing devices 100-1 and 100-2. The fixing devices 100-1 and 100-2 respectively comprise relays 102-1 and 102-2, fixing heaters 103-1 and 103-2, temperature sensors 104-1 and 104-2, and comparators 105-1 and 105-2. The fixing devices 100-1 and 100-2 are respectively connected to AC power supplies 106-1 and 106-2 as external power supplies.

The fixing controller 1010N/OFF-controls the two fixing heaters 103-1 and 103-2 in accordance with information such as the type of printing sheet, the temperatures of the fixing heaters, and fixing error detection information, and can control the temperatures of the fixing devices 100-1 and 100-2 or turn off the fixing heaters of the fixing devices 100-1 and 100-2 upon occurrence of an abnormality by ON/OFF-controlling the fixing heaters 103-1 and 103-2. The relays 102-1 and 102-2 are controlled by heater ON/OFF signals 107-1 and 107-2, and control the supply of power from the AC power supplies 106-1 and 106-2 to the fixing heaters 103-1 and 103-2. The fixing heaters 103-1 and 103-2 generate heat for fixing toner on a printing sheet. The temperature sensors 104-1 and 104-2 measure the temperatures of the fixing heaters 103-1 and 103-2.

The comparators 105-1 and 105-2 compare the temperatures measured by the temperature sensors 104-1 and 104-2 (the temperatures of the fixing heaters 103-1 and 103-2) with the preset temperature Tmax (predetermined temperature), and determine whether the measured temperatures exceed the predetermined temperature. If the measured temperatures exceed the predetermined temperature Tmax, output signals from the comparators 105-1 and 105-2 are activated to output error signals 1 and 2 indicated by 108-1 and 108-2 (signals indicating that the fixing heaters 103-1 and 103-2 are abnormal). If the measured temperatures do not exceed the predetermined temperature Tmax, the comparators 105-1 and 105-2 do not activate their output signals, and hence do not output error signals 1 and 2.

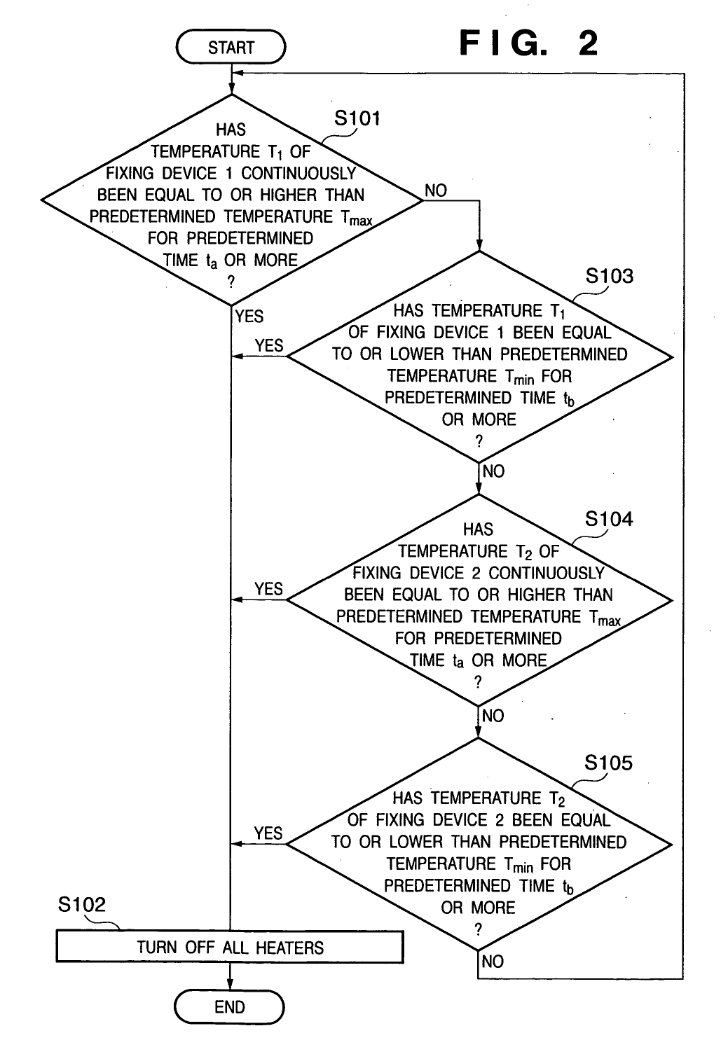

The AC power supplies 106-1 and 106-2 serve as power supplies for the fixing heaters 103-1 and 103-2. The signals 107-1 and 107-2 are ON/OFF signals for the relays 102-1 and 102-2. These signals serve to control the supply of power to the fixing heaters 103-1 and 103-2. Reference numerals 109-1 and 109-2 denote temperature signals, which are analog data representing the temperatures of the fixing heaters 103-1 and 103-2.

[Processing to be Performed by First Arrangement Upon Occurrence of Abnormality in Fixing Devices: FIG. 2]

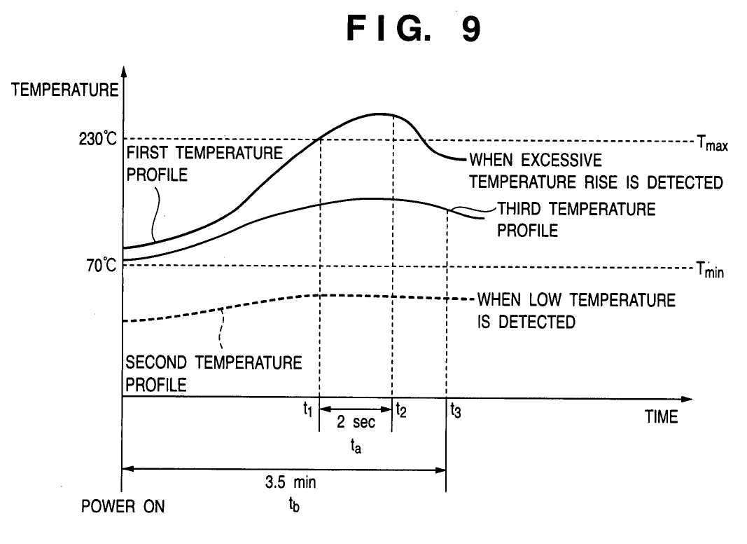

A control flow to be executed in the above arrangement comprising the fixing devices 100-1 and 100-2 and the fixing controller 101 when the fixing controller 101 detects an abnormality in at least one of the comparators 105-1 and 105-2 of the fixing devices 100-1 and 100-2 (when an excessive temperature rise or a low temperature is detected) will be described with reference to FIG. 2. For the sake of descriptive convenience, the following description is made by taking the temperature transition shown in FIG. 9 as an example of processing in accordance with the flowchart of FIG. 2. The following description can be applied to a temperature transition other than that shown in FIG. 9.

FIG. 9 shows an example of each of the temperature profiles of the fixing heaters 103-1 and 103-2 which are measured by the temperature sensors 104-1 and 104-2. More specifically, each profile shown in FIG. 9 is an example of each of the temperature profiles obtained when the fixing heaters 103-1 and 103-2 are heated while the set lower limit temperature Tmin for the fixing heaters 103-1 and 103-2 is set to 70° C., and the set upper limit temperature Tmax for the heaters is set to 230° C. The first temperature profile indicates a case of detection of an excessive temperature rise (i.e., a case wherein a temperature exceeding the set upper limit temperature Tmax (230° C.) is detected for the set time ta (2 sec) or more. The second temperature profile indicates a case of detection of a low temperature (i.e., a case wherein a temperature equal to or lower than the set lower limit temperature Tmin (70° C.) is detected for the set time tb (3.5 min) or more). The third temperature profile indicates a case wherein the heaters are normally heated (i.e., the set temperature range (70 to 230° C.)).

If it is determined in step S101 in FIG. 2 that an output signal from the comparator 105-1 of the fixing device 100-1 is activated, and the error signal 108-1 continues for a predetermined time (ta: 2 sec) or more (the predetermined upper limit temperature Tmax “230° C.” continues for 2 sec or more), the flow advances to step S102 to turn off the relays 102-1 and 102-2 to stop heating the fixing heaters (i.e., the fixing heaters 103-1 and 103-2) of all the fixing devices (this operation corresponds to processing at time t2 when the fixing heater 103-1 is heated in accordance with the first temperature profile in the case shown in FIG. 9).

If it is determined in step S101 that an output signal from the comparator 105-1 of the fixing device 100-1 is not active (the error signal 108-1 is not output), the flow advances to step S103 to check whether the temperature signal 109-1 from the fixing device 100-1 indicates a predetermined temperature (tmin: 70° C.) or higher within a predetermined time (tb: 3.5 min). If this signal does not indicate the predetermined temperature (tmin: 70° C.) or higher within the predetermined time (tb: 3.5 min), the flow advances to step S102 to stop heating all the fixing heaters (i.e., the fixing heaters 103-1 and 103-2) of all the fixing devices by turning off the relays 102-1 and 102-2 (this corresponds to the processing at time t3 in the case shown in FIG. 9 when the fixing heater 103-1 is heated in accordance with the second temperature profile).

If it is determined in step S103 that the temperature signal 109-1 from the fixing device 100-1 indicates a predetermined temperature (tmin: 70° C.) or higher within a predetermined time (tb: 3.5 min), the flow advances to step S104 (this corresponds to the processing at time t3 in the case shown in FIG. 9 when the fixing heater 103-1 is heated in accordance with the third temperature profile).

If it is determined in step S104 that an output signal from the comparator 105-2 of the fixing device 100-2 is active and the error signal 108-2 continues for a predetermined time (ta: 2 sec) or more (when the predetermined upper limit temperature Tmax “230° C.” continues for 2 sec or more), the flow advances to step S102 to stop heating the fixing heaters (i.e., the fixing heaters 103-1 and 103-2) of all the fixing devices by turning off the relays 102-1 and 102-2 (this corresponds to the processing at time t2 in the case shown in FIG. 9 when the fixing heater 103-2 is heated in accordance with the first temperature profile).

If it is determined in step S104 that an output signal from the comparator 105-2 of the fixing device 100-2 is not active (the error signal 108-2 is not output), the flow advances to step S105 to check whether the temperature signal 109-2 from the fixing device 100-2 indicates a predetermined temperature (tmin: 70° C.) or higher within a predetermined time (tb: 3.5 min). If the signal does not indicate the predetermined temperature (tmin: 70° C.) or higher within the predetermined time (tb: 3.5 min), the flow advances to step S102 to stop heating the fixing heaters (i.e., the fixing heaters 103-1 and 103-2) of all the fixing devices by turning off the relays 102-1 and 102-2 (this corresponds to the processing at time t3 in the case shown in FIG. 9 when the fixing heater 103-2 is heated in accordance with the second temperature profile).

If it is determined in step S105 that the temperature signal 109-2 from the fixing device 100-2 indicates a predetermined temperature (tmin: 70° C.) or higher within a predetermined time (tb: 3.5 min), the flow advances to step S101 (this corresponds to the processing at time t3 in the case shown in FIG. 9 when the fixing heater 103-2 is heated in accordance with the third temperature profile).

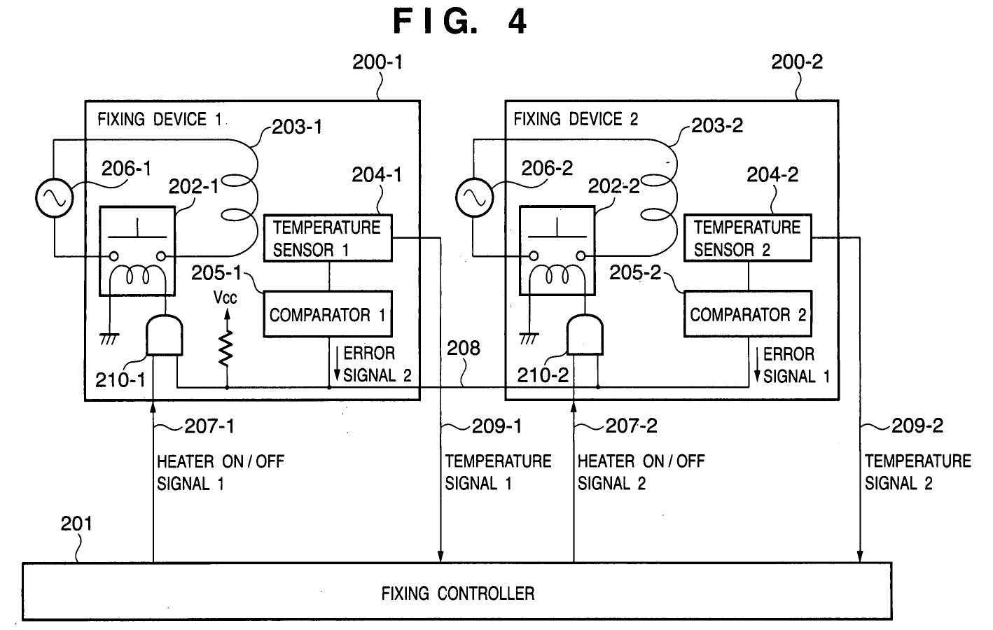

As described above, the image forming apparatus of the present invention includes two fixing devices and a fixing controller. Each fixing device includes a switch which supplies power to the fixing heater, a temperature sensor which measures the temperature of the fixing heater, and a comparator which determines from the measured temperature whether or not the fixing heater is operating normally, and outputs an error signal when determining that the fixing heater is abnormal. When, therefore, at least one of the comparators outputs an abnormal signal, the fixing controller can control the switches to stop supplying power to all the fixing devices. This allows the image forming apparatus of the present invention to form an image more safely.

[Control Arrangement (Second Arrangement) for Performing Abnormality Processing for Fixing Devices: FIG. 4]

The above description has exemplified the abnormality processing for the fixing devices in the arrangement comprising the fixing controller and the fixing devices each having the temperature sensor in FIG. 1. However, processing similar to that described above can also be performed in the arrangement shown in FIG. 4. Note that since the processing in FIG. 4 is similar to the processing described with reference to FIGS. 1 and 2, a description of common parts will be omitted, and only points different from those in the arrangement shown in FIG. 1 will be described below.

FIG. 4 is a block diagram showing a control system for a case wherein abnormality processing for each fixing device, which is described with reference FIG. 1, is performed by another arrangement. The control system comprises a fixing controller 201 and two fixing devices 200-1 and 200-2. The fixing devices 200-1 and 200-2 in FIG. 4 respectively comprise relays 202-1 and 202-2, fixing heaters 203-1 and 203-2, temperature sensors 204-1 and 204-2, comparators 205-1 and 205-2, and AND circuits 210-1 and 210-2. The fixing devices 200-1 and 200-2 are respectively connected to AC power supplies 206-1 and 206-2 as external power supplies.

The arrangement shown in FIG. 4 differs from that shown in FIG. 1 in that when output signals from the comparators 205-1 and 205-2 are activated, an error signal 208 is not output to the fixing controller 201 unlike in FIG. 1, but is input to the AND circuits 210-1 and 210-2 in the fixing devices 200-1 and 200-2, and the relays 202-1 and 202-2 are controlled by using output signals from the AND circuits 210-1 and 210-2 (in this case, the signals output from the comparators 205-1 and 205-2 are open collector outputs).

If the temperature of a fixing heater exceeds the set upper limit temperature, output signals from the comparators 205-1 and 205-2 are activated to output an error signal. This signal is input to the AND circuits 210-1 and 210-2. As a consequence, the AND circuits 210-1 and 210-2 output signals to turn off the relays 202-1 and 202-2, thereby stopping heating the fixing heaters (i.e., the fixing heaters 203-1 and 203-2) of all the fixing devices.

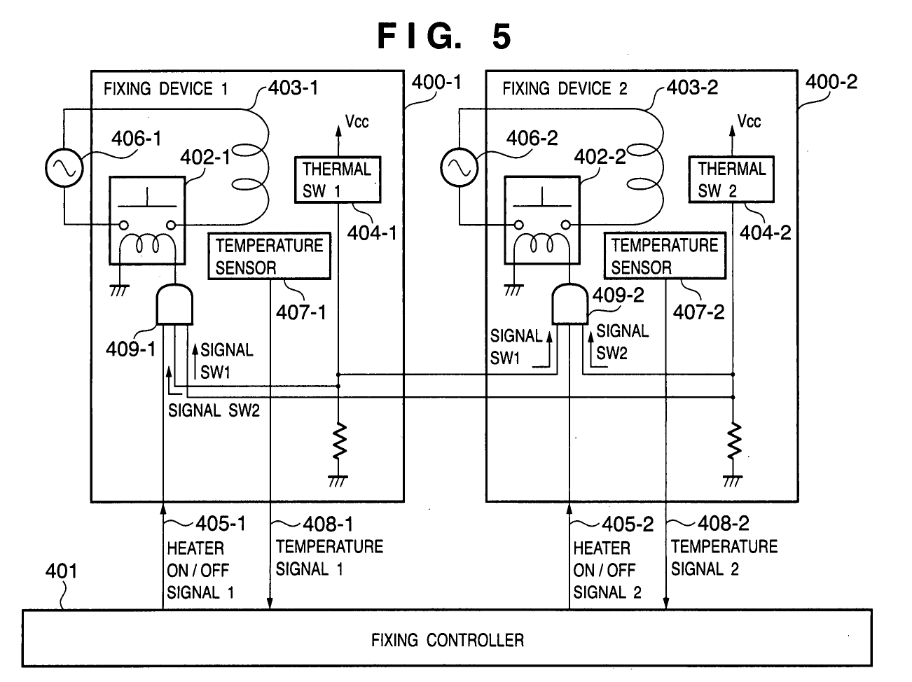

In this manner, in the second arrangement shown in FIG. 4, when the measured temperature of one of the fixing heaters of the fixing devices 200-1 and 200-2 exceeds the set upper limit temperature Tmax, it is determined that the fixing heater is abnormal, and the switches are controlled to stop the supply of power to all the fixing devices. Therefore, the image forming apparatus of the present invention can form an image more safely.

[Control Arrangement (Third Arrangement) for Performing Abnormality Processing for Fixing Devices: FIG. 5]

The description of the abnormality processing for the fixing devices, which has been made with reference to FIGS. 1 and 4, has exemplified the arrangement in which the fixing devices use the temperature sensors. However, the present invention can be realized by an arrangement using thermal switches in place of the temperature sensors as shown in FIG. 5. Abnormality processing in this arrangement will be described below. A description of portions common to those in FIGS. 1 and 2 will be omitted, and only different points will be described.

FIG. 5 is a block diagram showing a control system for performing abnormality processing for fixing devices in an image forming apparatus with an arrangement using thermal switches. The control system comprises a fixing controller 401 and two fixing devices 400-1 and 400-2. The fixing devices 400-1 and 400-2 respectively comprise relays 402-1 and 402-2, fixing heaters 403-1 and 403-2, thermal switches 404-1 and 404-2, temperature sensors 407-1 and 407-2, and AND circuits 409-1 and 409-2. The fixing devices 400-1 and 400-2 are respectively connected to AC power supplies 406-1 and 406-2 as external power supplies.

The fixing controller 4010N/OFF-controls the two fixing heaters 403-1 and 403-2 in accordance with information such as the type of printing sheet, the temperatures of the fixing heaters, and fixing error detection information. The fixing controller 401 can control the temperatures of the fixing devices 400-1 and 400-2 by ON/OFF-controlling the fixing heaters 403-1 and 403-2, and turn off the fixing heaters upon occurrence of an abnormality in the fixing devices 400-1 and 400-2. The relays 402-1 and 402-2 are controlled by output signals from the AND circuits 409-1 and 409-2 to control the supply of power from the AC power supplies 406-1 and 406-2 to the fixing heaters 403-1 and 403-2.

In this case, each of the output signals from the AND circuits 409-1 and 409-2 is controlled by three signals, i.e., one of heater ON/OFF signals 405-1 and 405-2 and signals SW1 and SW2 output from the thermal switches 404-1 and 404-2. More specifically, when all the three signals are input to each of the AND circuits 409-1 and 409-2, each AND circuit outputs an output signal. As a result, the relays 402-1 and 402-2 are operated to supply power from the AC power supplies 406-1 and 406-2 to the fixing heaters 403-1 and 403-2. If, one of the three signals ceases to be input, for example, one of the signals SW1 and SW2 ceases to be input when one of the thermal switches 404-1 and 404-2 is turned off, the AND circuits 409-1 and 409-2 stop outputting output signals. As a consequence, the relays 402-1 and 402-2 are inactivated to stop the supply of power from the AC power supplies 406-1 and 406-2 to the fixing heaters 403-1 and 403-2.

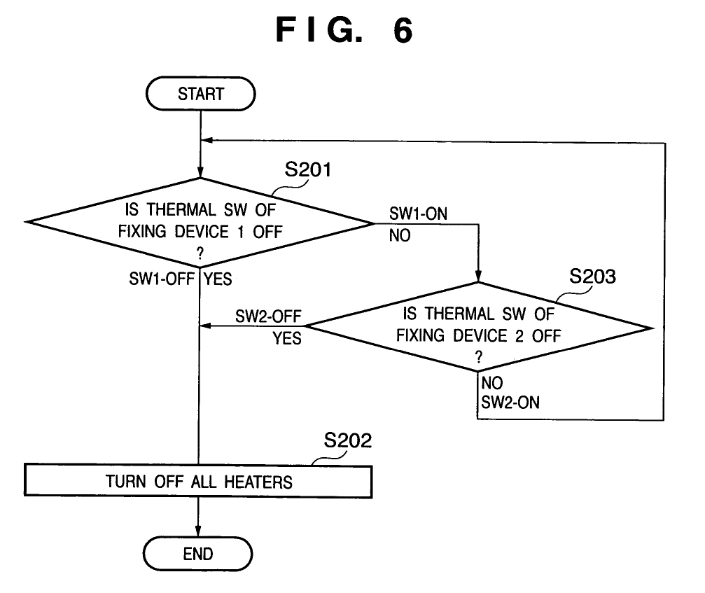

The fixing heaters 403-1 and 403-2 generate heat for fixing toner on a printing sheet. The thermal switches 404-1 and 404-2 are switches which turn off the circuits when the temperatures of the fixing heaters 403-1 and 403-2 become the predetermined temperature Tmax (e.g., 230° C.) or higher. The relay ON/OFF signals 405-1 and 405-2 are signals which control the supply of power to the fixing heaters, and are controlled by temperature signals 408-1 and 408-2 measured by the temperature sensors 407-1 and 407-2. The AC power supplies 406-1 and 406-2 are power supplies for the fixing heaters. The temperature sensors 407-1 and 407-2 measure the temperatures of the fixing heaters 403-1 and 403-2. The temperature signals 408-1 and 408-2 are analog data representing the temperatures of the fixing heaters.

[Processing to Be Performed by Third Arrangement upon Occurrence of Abnormality in Fixing Device: FIG. 6]

A control flow to be executed in the above arrangement comprising the fixing devices 400-1 and 400-2 and the fixing controller 401 when at least one of the thermal switches 404-1 and 404-2 of the two fixing devices 400-1 and 400-2 is turned off upon detection of a temperature equal to or higher than the set upper limit temperature Tmax will be described with reference to FIG. 6.

If it is determined in step S201 in FIG. 6 that the thermal switch 404-1 of the first fixing device 400-1 is OFF (a temperature equal to or higher than the upper limit temperature Tmax is detected), the flow advances to step S202, as is obvious from the arrangement shown in FIG. 5. In this step, all the relays 402-1 and 402-2 are turned off to stop heating the fixing heaters (i.e., the fixing heaters 403-1 and 403-2) of all the fixing devices.

If it is determined in step S201 that the thermal switch 404-1 of the fixing device 400-1 is ON (any temperature equal to or higher than the upper limit temperature Tmax is not detected), the flow advances to step S203. If it is determined in step S203 that the thermal switch 404-2 of the second fixing device 400-2 is OFF (a temperature equal to or higher than the upper limit temperature Tmax is detected), the flow advances to step S202, as is obvious from the arrangement shown in FIG. 5. As a result, all the relays 402-1 and 402-2 are turned off to stop heating the fixing heaters (i.e., the fixing heaters 403-1 and 403-2) of all the fixing devices.

If it is determined in step S203 that the thermal switch 404-2 of the fixing device 400-2 is ON (any temperature equal to or higher than the upper limit temperature Tmax is not detected), the flow returns to step S201.

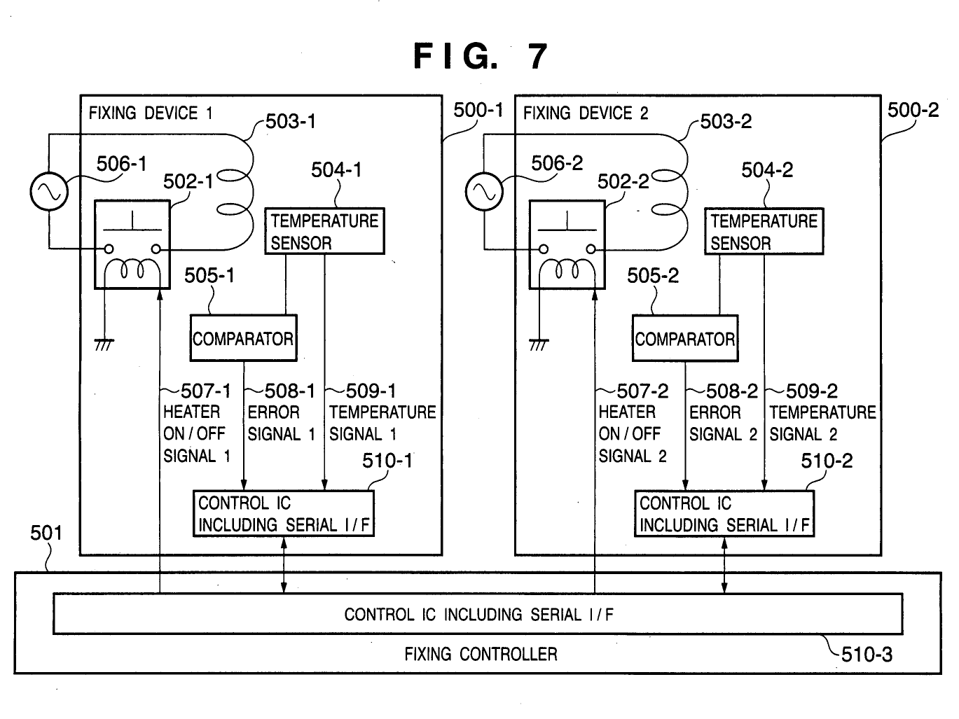

In this manner, in the third arrangement shown in FIG. 5, when the measured temperature of one of the fixing heaters of the fixing devices 400-1 and 400-2 exceeds the set upper limit temperature Tmax, the thermal switch is turned off, and it is determined that the fixing heater is abnormal, thereby controlling the switches to stop the supply of power to all the fixing devices. Therefore, the image forming apparatus of the present invention can form an image more safely.

[Control Arrangement (Fourth Arrangement) for Abnormality Processing for Fixing Devices: FIG. 7]

Abnormality processing for each fixing device in the arrangement exemplified in each of FIGS. 1, 4, and 5 is performed such that the fixing heaters are turned off when a temperature abnormality is detected. However, this abnormality processing is not limited to that to be performed upon detection of a temperature. For example, as shown in FIG. 7, fixing devices and a fixing controller may incorporate serial I/Fs, so that when normal communication cannot be conducted between them, the fixing devices are turned off to ensure the safety of the image forming apparatus. Abnormality processing in this arrangement will be described below.

FIG. 7 is a block diagram showing a control system which performs abnormality processing for the fixing devices in the image forming apparatus with the arrangement using serial I/Fs. This apparatus comprises a fixing controller 501 having a control IC 510-3 including a serial I/F and two fixing devices 500-1 and 500-2. The fixing devices 500-1 and 500-2 respectively comprise relays 502-1 and 502-2, fixing heaters 503-1 and 503-2, temperature sensors 504-1 and 504-2, comparators 505-1 and 505-2, and control ICs 510-1 and 510-2 including serial I/Fs. The fixing devices 500-1 and 500-2 are respectively connected to AC power supplies 506-1 and 506-2 as external power supplies.

The fixing controller 5010N/OFF-controls the two fixing heaters 503-1 and 503-2 in accordance with information such as the type of printing sheet, the temperatures of the fixing heaters, and fixing error detection information. The fixing controller 501 can control the temperatures of the fixing devices 500-1 and 500-2 by ON/OFF-controlling the fixing heaters 503-1 and 503-2, and turn off the fixing heaters upon occurrence of an abnormality in the fixing devices 500-1 and 500-2. The relays 502-1 and 502-2 are controlled by heater ON/OFF signals 507-1 and 507-2 to control the supply of power from the AC power supplies 506-1 and 506-2 to the fixing heaters 503-1 and 503-2. The fixing heaters 503-1 and 503-2 generate heat for fixing toner on a printing sheet. The temperature sensors 504-1 and 504-2 measure the temperatures of the fixing heaters 503-1 and 503-2.

The comparators 505-1 and 505-2 compare measured temperatures from the temperature sensors 504-1 and 504-2 (the temperatures of the fixing heaters 503-1 and 503-2) with a preset temperature Tmax (predetermined temperature) to determine whether or not the measured temperatures exceed the predetermined temperature. If the measured temperatures exceed the predetermined temperature Tmax, output signals from the comparators 505-1 and 505-2 are activated to output error signals 1 and 2 indicated by 508-1 and 508-2 (signals indicating that the fixing heaters 503-1 and 503-2 are abnormal). If the measured temperatures do not exceed the predetermined temperature Tmax, the comparators 505-1 and 505-2 do not activate their output signals and hence do not output error signals 1 and 2.

The AC power supplies 506-1 and 506-2 are power supplies for the fixing heaters. The signals 507-1 and 507-2 are ON/OFF signals for the relays, and are signals which control the supply of power to the fixing heaters 503-1 and 503-2. Reference numerals 509-1 and 509-2 denote temperature signals, which are analog data representing the temperatures of the fixing heaters; and 510-1, 510-2, and 510-3, control ICs including serial I/Fs. Data can be exchanged between the control ICs 510-1 and 510-3 and between the control ICs 510-2 and 510-3 by serial communication.

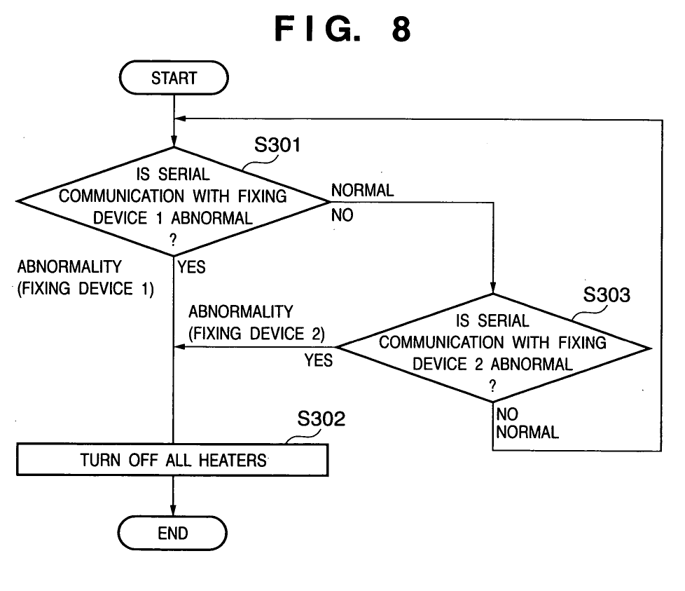

Note that when the control IC 510-1 including the serial I/F receives the error signal 508-1 from the comparator 505-1, the control IC 510-1 including the serial I/F can stop serial communication with the control IC 510-3 including the serial I/F. Likewise, when the control IC 510-2 including the serial I/F receives the error signal 508-2 from the comparator 505-2, the control IC 510-2 including the serial I/F can stop serial communication with the control IC 510-3 including the serial I/F. At this time, when the control IC 510-3 including the serial I/F detects this abnormal state (e.g., detects that serial communication from the control IC 510-1 including the serial I/F to the control IC 510-3 including the serial I/F is stopped, or serial communication from the control IC 510-2 including the serial I/F to the control IC 510-3 including the serial I/F is stopped), all the relays 502-1 and 502-2 are turned off by using the ON/OFF signals 507-1 and 507-2 for the relays, thereby stopping the heating of the fixing heaters (i.e., the fixing heaters 503-1 and 503-2) of all the fixing devices.

[Processing to be Performed by Fourth Arrangement Upon Occurrence of Abnormality in Fixing Device: FIG. 8]

FIG. 8 shows a control flow to be executed in the above arrangement comprising the fixing controller 501 and the two fixing devices 500-1 and 500-2 when at least one of serial communication between the fixing device 500-1 and the fixing controller 501 and serial communication between the fixing device 500-2 and the fixing controller 501 cannot be performed. This control is executed while a CPU (not shown) in the image forming apparatus controls the respective components by using RAM (not shown) in accordance with a control program stored in ROM (not shown).

First of all, if it is determined in step S301 in FIG. 8 that serial communication between the first fixing device 500-1 and the fixing controller 501 is abnormal (e.g. when the control IC 510-1 including the serial I/F stops sending a response signal to the control IC 510-1 including the serial I/F, when a parity check using a parity bit contained in serial transfer data indicates an error, when an error is found by data comparison performed by transmitting the same data a plurality of number of times, or when an error is found by a loopback check (data comparison upon reception of transmitted data without any change)), the flow advances to step S302, in which upon detecting the abnormal state (detecting that serial communication from the control IC 510-1 including the serial I/F to the control IC 510-3 including the serial I/F is stopped), the control IC 510-3 turns off all the relays 502-1 and 502-2 by using the ON/OFF signals 507-1 and 507-2 for the relays, thereby stopping heating the fixing heaters (i.e., the fixing heaters 503-1 and 503-2) of all the fixing devices.

If it is determined in step S301 that serial communication can be normally done between the first fixing device 500-1 and the fixing controller 501, the flow advances to step S303. If it is determined in step S303 that serial communication between the second fixing device 500-2 and the fixing controller 501 is abnormal (when the control IC 510-2 including the serial I/F stops sending a response signal to the control IC 510-3 including the serial I/F, when a parity check performed by using a parity bit contained in serial transfer data indicates an error, when an error is found by data comparison performed by transmitting the same data a plurality of number of times, or when an error is found by a loopback check (data comparison upon reception of transmitted data without any change)), the flow advances to step S303, in which upon detecting the abnormal state (detecting that serial communication from the control IC 510-2 including the serial I/F to the control IC 510-3 including the serial I/F is stopped), the control IC 510-3 including the serial I/F turns off all the relays 502-1 and 502-2 by using the ON/OFF signals 507-1 and 507-2 for the relays, thereby stopping heating the fixing heaters (i.e., the fixing heaters 503-1 and 503-2) of all the fixing devices.

If it is determined in step S303 that the control IC 510-3 including the serial I/F does not detect the abnormal state, the flow returns to step S301.

In this manner, in the fourth arrangement shown in FIG. 7, when at least one of serial communication between the fixing device 500-1 and the fixing controller 501 and serial communication between the fixing device 500-2 and the fixing controller 501 cannot be performed because of a failure in one of the fixing devices 500-1 and 500-2, it is discriminated that an abnormality has occurred in one of the fixing devices, and the switches are controlled to stop the supply of power to all the fixing devices. This allows the image forming apparatus of the present invention to form an image more safely.

### Other Embodiment

The present invention can take embodiments as, for example, an apparatus, method, program, and storage medium. More specifically, the present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is realized even by supplying a storage medium (or a recording medium) storing software program codes for realizing the functions of the above-described embodiment to a system or apparatus, and causing the computer (or a CPU or MPU) of the system or apparatus to read out and execute the program codes stored in the storage medium. In this case, the program codes read out from the storage medium realize the functions of the above-described embodiment by themselves, and the storage medium storing the program codes constitutes the present invention.

The functions of the above-described embodiment are realized not only when the readout program codes are executed by the computer but also when the OS (Operating System) running on the computer performs part or all of actual processing on the basis of the instructions of the program codes.

The functions of the above-described embodiment are also realized when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes. When the present invention is to be applied to the above storage medium, program codes corresponding to the above-described flowcharts (shown in FIGS. 2, 6, and 8) are stored in the storage medium.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-217771 filed on Jul. 26, 2004, which is hereby incorporated by reference herein.

What is claimed is:

1. An image forming apparatus comprising:
a plurality of fixing devices each including a fixing heater which fixes a developing agent on a recording medium, a switch which turns on/off supply of power to the fixing heater, and an abnormality detection unit which detects an abnormality of the fixing heater; and
a control unit which turns off all the switches of said plurality of fixing devices so as to stop supply of power to all said plurality of fixing devices, when an abnormality is detected by the abnormality detection unit of at least one of said fixing devices, regardless of a detection result by the abnormality detection unit of said other fixing device.

2. The apparatus according to claim 1, wherein the abnormality detection unit includes a temperature sensor which measures a temperature of the fixing heater, and a comparison unit which compares a temperature measured by the temperature sensor with a predetermined temperature, and outputs an error signal when the measured temperature exceeds the predetermined temperature, and said control unit turns off all switches of said plurality of fixing devices when the error signal is continuously output for not less than a predetermined time.

3. The apparatus according to claim 1, wherein the abnormality detection unit includes a temperature sensor which measures a temperature of the fixing heater, and said control unit turns off all switches of said plurality of fixing devices when a temperature measured by the temperature sensor does not reach a predetermined temperature within a predetermined time.

4. The apparatus according to claim 1, wherein the abnormality detection unit includes a thermal switch which cuts off an output signal when a temperature of the fixing heater exceeds a predetermined temperature, and said control unit turns off switches of all said plurality of fixing devices when the thermal switch cuts off an output signal.

5. The apparatus according to claim 1, wherein the power is supplied from an external power supply.

6. A control method for an image forming apparatus having a plurality of fixing devices each including a fixing heater which fixes a developing agent on a recording medium, a switch which turns on/off supply of power to the fixing heater, and an abnormality detection unit which detects an abnormality of the fixing heater, comprising:
an abnormality detection step of detecting an abnormality of the fixing heater by using the abnormality detection unit; and
a control step of turning off all the switches of the plurality of fixing devices so as to stop supply of power to all the plurality of fixing devices, when an abnormality is detected by the abnormality detection unit of at least one of the fixing devices, regardless of a detection result by the abnormality detection unit of the other fixing device.

7. An image forming apparatus comprising:
a plurality of fixing devices each including a fixing heater which fixes a developing agent on a recording medium, a switch which turns on/off supply of power to the fixing heater, and a serial communication unit which performs communication by using serial data; and
a control unit which turns off all the switches of said plurality of fixing devices to stop supply of power to all said plurality of fixing devices when a communication abnormality is detected in the serial communication unit of at least one of said fixing devices.
